(19) United States
(12) Patent Application Publication
(10) Pub. No.: US 2020/0267204 A1
(43) Pub. Date: Aug. 20, 2020

(54) REMOTE ADMINISTRATION TECHNIQUE

(71) Applicant: ORANGE, Paris (FR)

(72) Inventors: Emna Mezghani, Chatillon Cedex (FR); Samuel Berlemont, Chatillon Cedex (FR); Julien Rouland, Chatillon Cedex (FR)

(21) Appl. No.: 16/651,672

(22) PCT Filed: Sep. 25, 2018
(86) PCT No.: PCT/FR2018/052358

§ 371 Date: Mar. 27, 2020

(30) Foreign Application Priority Data
Sep. 29, 2017 (FR) 1759098

(51) Int. Cl. H04L 29/08; H04L 12/24; G06F 9/48

(52) U.S. Cl. CPC H04L 67/025; G06F 9/485; H04L 41/0893

(57) ABSTRACT

Remote administering a device by an administration server. A management operation is to be executed by the administration server on the device. A piece of information on state of use of the device is then obtained and an execution impact of the management operation is evaluated for a quality of service for a service supplied by the device, depending on the piece of information obtained and the management operation to be executed. A postponement of the execution of the management operation is requested from the administration server. This postponement is determined according to the piece of information obtained, that impact and a policy for executing management operation defining an association between a state of use of a device, an operation and an impact.

### CROSS-REFERENCE TO RELATED APPLICATIONS

This application is a Section 371 National Stage Application of International Application No. PCT/FR2018/052358, filed Sep. 25, 2018, the content of which is incorporated herein by reference in its entirety, and published as WO 2019/063932 on Apr. 4, 2019, not in English.

### FIELD OF THE DISCLOSURE

The invention is concerned with the general field of telecommunications.

The invention relates more particularly to the remote administration of a device by an administration server. This device belongs for example to a local area network.

### BACKGROUND OF THE DISCLOSURE

In order to guarantee quality services, it is preferable that a network operator be able to administer devices remotely.

Remote administration of devices requires in particular:
detection and knowledge of the administered devices, for example their serial numbers, their hardware and software versions;
monitoring of these devices, for example by obtaining monitoring information and performance indicators.

In a local area network, an access gateway allows, in particular, devices located on a client site to access a WAN (for “Wide Area Network”) wide area communication network, such as the Internet network. These devices are also called CPE, for “Customer Premises Equipment”. For a local area network, this entails in particular the access gateway, a “Set-Top-Box” TV decoder, a mobile terminal. In the context of a home-automation network, this also entails electro-domestic equipment, alarm systems, sensors.

Remote management of the devices of a local area network draws for example upon a technical report compiled by the Broadband Forum, TR-069 “CPE WAN Management Protocol”. This technical report defines a CWMP protocol, specifying the communication between an administration server, called remote auto-configuration server ACS (for “Auto-configuration Server”), and a device of the local area network. The CWMP protocol defines a mechanism which allows, in particular, secure auto-configuration of the devices of the local area network and of other management functions of these devices.

It is in particular possible for the operator of the network to perform remote interventions, such as:
update the software or the microcode (“firmware”) of a device, when an upgrade of the software version or of the microcode is required;
perform a diagnosis when a device exhibits a malfunction;
install and dynamically configure new services;
monitor the operating state and the performance of a device.

The CWMP protocol draws upon the Internet protocol, more precisely on TCP/IP (for “Transmission Control Protocol”).

The remote updating of software or of microcode is an operation requiring particular precautions. It is preferable not to interrupt it while it is executing. Indeed, this risks corrupting the software or the microcode and preventing the functioning of the device while updating. Moreover, the updating operation can generate a service interruption at the level of the device. When the device is an access gateway to the wide area network for a set of devices of a local area network, the service is also interrupted for this set of devices. The updates are then often programmed by the operator to execute during the night so as to limit the impacts thereof. There is, however, no guarantee that the device to be updated is not in use during a nighttime update. It is stressed here that the updates are generally performed without a request for validation on the part of a user of the device. This issue related to the execution of an update arises for any remotely administered device.

### SUMMARY

One of the aims of the invention is to remedy inadequacies/drawbacks of the prior art and/or to afford improvements thereto.

According to a first aspect, the subject of the invention is a method of remote administration of a device by an administration server. This method comprises:
an obtaining of an item of information in respect of state of use of the device for which a management operation is to be executed;
a request to the administration server for postponement of the execution of the management operation, said postponement being determined as a function of the item of information obtained, of an evaluation of an impact of the execution of the management operation on the functioning of the device and of a management operation execution policy.

More precisely, the method comprises:
obtaining of an item of information in respect of state of use of the device for which a management operation is to be executed;
evaluation of an impact of the execution of the management operation for a quality of service for a service provided by the device as a function of the item of information obtained and of the management operation to be executed:
determination of a postponement of the execution of the management operation as a function of the item of information obtained, of said impact and of a management operation execution policy, defining an association between a state of use of a device, an operation and an impact;
requesting the postponement of the execution of the management operation from the administration server.

The remote administration method stems originally from a problem associated with an updating of the software or of the firmware of a device, liable to bring about complete stoppage of the service or services provided by this device. It is however applicable to any management operation to be executed on this device. The implementation of the administration method as proposed makes it possible to minimize the impact of a management operation on the quality of service provided to the user of the device.

It is understood that, thus by virtue of the method, the impact of the management operation for a user of the device is limited. This is particularly significant when this updating brings about a service interruption associated with a rebooting of the device.

This method is in particular advantageous when the network operator does not have at their disposal any technical means of forewarning the person or persons liable to use the device and of requesting them for their agreement before performing a management operation. Indeed, certain devices do not have at their disposal an elaborate man-machine interface allowing them to interact in a simple and user-friendly manner with the user or users. This is the case for example for TV decoders, access points for the wide area communication network, residential gateways. Thus, a postponement of the management operation can be decided on as a function of a state of use of the device on which this management operation must be executed.

A state of use of the device is representative of an availability of the device with a view to a management operation. This state of use takes into account one or more services currently executing on the device and/or resources of the device. It makes it possible to evaluate an impact of a management operation on the device, in particular on the quality of service for a service provided by the device. In one embodiment, the service is a main service provided by the device. In another embodiment, the service is a service provided by the device and currently in use. This evaluation of an impact on the quality of service is not taken into account in the remote administration schemes known to date.

The implementation of the proposed method of remote administration thus makes it possible to adapt the existing schemes by evaluating an impact of a management operation as a function of a state of use of the device. This results in remote administration adapted to the device targeted by the management operation making it possible to guarantee availability of the services to the users of the device and thus to offer them a better quality of service. The various embodiments or characteristics of embodiment mentioned hereinafter can be added independently or in combination with one another, to the steps of the remote administration method such as is defined above.

In a particular embodiment, the request for postponement of the execution of the management operation comprises a temporal item of information allowing the administration server to orchestrate the execution of the management operation.

In this embodiment, this allows the administration server to orchestrate the execution of the management operation, without making it necessary to implement the administration method again.

In a particular embodiment, the postponement of the execution of the management operation is also determined as a function of a context associated with a user of the device.

The context associated with a user of the device comprises one or more items of information relating to a user of the device or to the environment thereof. This may entail preferred timetables for a management operation, profile of the user, etc. In this embodiment, the execution of the management operation takes this context into account so as to adapt the quality of service to the user.

In a particular embodiment, the item of information in respect of state of use of the device is determined on the basis of information collected from the device.

In this embodiment, the device itself provides the information making it possible to determine the item of information in respect of state of use of the device. This allows better account to be taken of the use which is made of the device to evaluate the impact of the management operation.

According to a particular characteristic, the collected information belongs to the group comprising information relating to a process currently executing on the device, information relating to the resources available on the device.

This makes it possible to take account when determining a state of use of the information provided by the device such as the resources available in terms of random-access memory, of processor capacities, and also the service or services currently executing on the device.

In a particular embodiment, the impact is evaluated as a function of a class of the management operation.

According to a second aspect, the invention also relates to an administration device designed to cooperate with a server for remote administration of a device. The administration device comprises:
an obtaining module, designed to obtain an item of information in respect of state of use of the device for which a management operation is to be executed;
a scheduling module, designed to determine a postponement of the execution of the management operation as a function of the item of information obtained, of an evaluation of an impact of the execution of the management operation on the functioning of the device and of a management operation execution policy and to request the postponement from the administration server.

More precisely, the scheduling module is designed to evaluate an impact of the execution of the management operation for a quality of service for a service provided by the device as a function of the item of information obtained and of the management operation to be executed, to determine a postponement of the execution of the management operation as a function of the item of information obtained, of an evaluation of said impact and of a management operation execution policy defining an association between a state of use of a device, an operation and an impact and to request the postponement from the administration server.

In a particular embodiment, the administration device and the device to be administered are united into a single device.

The advantages stated for the remote administration method according to the first aspect are transposable directly to the administration device.

In a particular embodiment, the obtaining module is furthermore designed to determine the item of information in respect of state of use of the device on the basis of information collected from the device.

This administration device can of course comprise in structural terms the various characteristics which relate to the administration method such as is described above and which can be combined or taken in isolation.

According to a third aspect, the invention also relates to a system designed to cooperate with a remote administration server. This system comprises:

at least one device to be administered comprising:
an administration module, designed to be administered remotely by an administration server;
a module, designed to collect information relating to the device making it possible to determine an item of information in respect of state of use of the device;
   said system furthermore comprising:
a determination module for determining a state of use, designed to determine an item of information in respect of state of use of the device for which a management operation is to be executed;
a scheduling module, designed to determine a postponement of the execution of the management operation as a function of the item of information obtained, of an evaluation of an impact of the execution of the management operation on the functioning of the device and of a management operation execution policy and to request the postponement from the administration server.

More precisely, the scheduling module is designed to evaluate an impact of the execution of the management operation for a quality of service for a service provided by the device as a function of the item of information obtained and of the management operation to be executed, to determine a postponement of the execution of the management operation as a function of the item of information obtained, of an evaluation of said impact and of a management operation execution policy defining an association between a state of use of a device, an operation and an impact and to request the postponement from the administration server.

The advantages stated for the remote administration method according to the first aspect are transposable directly to the system.

According to a particular characteristic, the system furthermore comprises a collection module, designed to obtain information relating to the device making it possible to determine an item of information in respect of state of use of the device.

This system can of course comprise in structural terms the various characteristics which relate to the administration method such as is described above and which can be combined or taken in isolation.

According to a fourth aspect, the invention relates to a program for a device, comprising program code instructions intended to control the execution of those of the steps of the above-described remote administration method which are implemented by the device, when this program is executed by this device and a recording medium readable by a device on which a program for a device is recorded.

The advantages stated for the remote administration method according to the first aspect are transposable directly to the program for a device and to the recording medium.

### BRIEF DESCRIPTION OF THE DRAWINGS

The technique for remote administration of a device will be better understood with the aid of the following description of particular embodiments, with reference to the appended drawings in which:

FIG. 1 represents a remote administration environment in a communication network in a particular embodiment;

FIG. 2 illustrates an exemplary implementation of a remote administration method according to a particular embodiment;

FIG. 3 illustrates steps of a remote administration method according to a particular embodiment;

FIG. 4 represents a remotely administrable device according to a particular embodiment;

FIG. 5 represents an administration device according to a particular embodiment.

### DETAILED DESCRIPTION OF ILLUSTRATIVE EMBODIMENTS

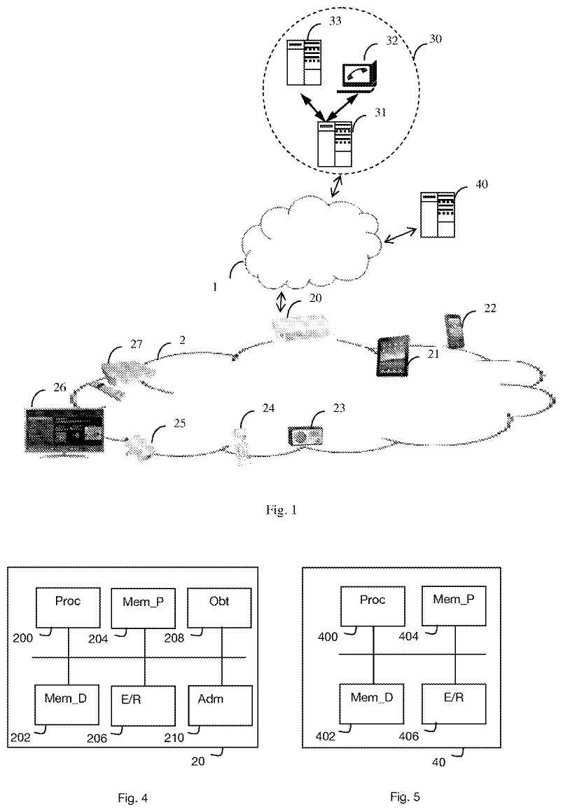

The environment represented in FIG. 1 corresponds to that of the remote administration of devices of a local area network. It is given here by way of illustration, the remote administration technique being able to be implemented in other environments.

FIG. 1 represents a plurality of devices of a local area network that are administered remotely by a set of administration equipment. The IP (for “Internet Protocol”) protocol is used by the devices to communicate with one another in the local area network and also to communicate with a wide area communication network or WAN (for “Wide Area Network”), such as the Internet network, not represented in FIG. 1.

For the environment represented in FIG. 1, by local area communication network 2 is meant a network of LAN (“Local Area Network”) type. This network can in particular be a domestic network or an enterprise network. An access gateway 20 is designed to provide access to the wide area communication network (for example Internet) to devices of the local area network, by way of an access network 1. The access network 1 is for example an xDSL access network (for “Digital Subscriber Line”, the x indicating that this may be an ADSL, HDSL, VDSL network, etc.). It may also be an FTTH (for “Fiber To The Home”) network. No limitation is attached to the type of the access network.

The local area network 2 can equally well be a wired network of Ethernet type, according to standard IEEE 802.3, or a wireless network of Wi-Fi type, according to standard IEEE 802.11 or else a PLC power line communication network.

The devices of a local area network 2 can be any devices whatsoever, for example domestic, having at their disposal a wired or wireless network connection. This may be for example, a computer, a touch tablet 21, a mobile telephone 22, a connected radio set 23, a fixed telephone 24, a backprojector 25, a television 26, a TV decoder (“Set-Top Box”) 27, a games console, electro-domestic devices, etc. We limit ourselves hereinafter to devices administered remotely by the set of administration equipment. These devices are also called CPE, for “Customer Premises Equipment”. Such devices contribute to the implementation of a service provided by the operator at a client's premises. In this regard, they provide a service to a user. This entails for example the gateway 20 for access to the wide area communication network, the TV decoder 27, a home-automation network controller, etc.

The set of administration equipment groups together a plurality of equipment allowing the operator of the communication network to administer and to monitor devices, particularly devices belonging to local area networks, including the access gateway 20 and the TV decoder 27. The set 30 of administration equipment comprises in particular an administration server 31, also called auto-configuration server ACS (for “Auto-Configuration Server”), a call center 32 and operational support centers 33 (OSS, for “Operational Support System”) or business oriented centers (BSS, for “Business Support System”).

In the embodiment described, the administration server 31 dialogs with the devices of the local area network 2 with a view to their administration according to the CWMP remote management protocol (“CPE WAN Management Protocol”) defined in technical report TR-069 compiled by the Broadband Forum, for example Amendment 5, dated November 2013. The data models used by the CWMP protocol are defined in technical report TR-181 “Device Data Model for TR-069”, for example the Issue 2 Amendment 11 version, dated July 2016. No limitation is attached to the use of this particular protocol. In other embodiments, it is for example possible to implement the OMA-Device Management specification defined by the OMA (for “Open Mobile Alliance”) organization for the administration of mobile terminals, for example approved version 2.0.

By means of the CWMP protocol, the administration server 31 can in particular:
obtaining and manage the configuration of a device remotely;
initiate diagnostics tests;
download software files or microcode files and
manage events.

In the case of an access gateway, the administration server 31 can also obtain information relating to the devices which are connected to it.

The remote administration application uses the CWMP protocol and draws upon protocol standards TCP/IP, SSL/TLS (for “Secure Sockets Layer/Transport Layer Security”, HTTP (for “HyperText Transfer Protocol”), SOAP (for “Simple Object Access Protocol”), RPC (for “Remote Procedure Call”).

In FIG. 1 an administration device 40 whose functions are detailed hereinafter is also represented.

By way of illustration, a standpoint within the framework of a domestic local area network is adopted hereinafter. No limitation is attached to this particular example and the description which follows is readily transposable to a local area network of enterprise network type. It is also transposable to any type of device to be administered remotely.

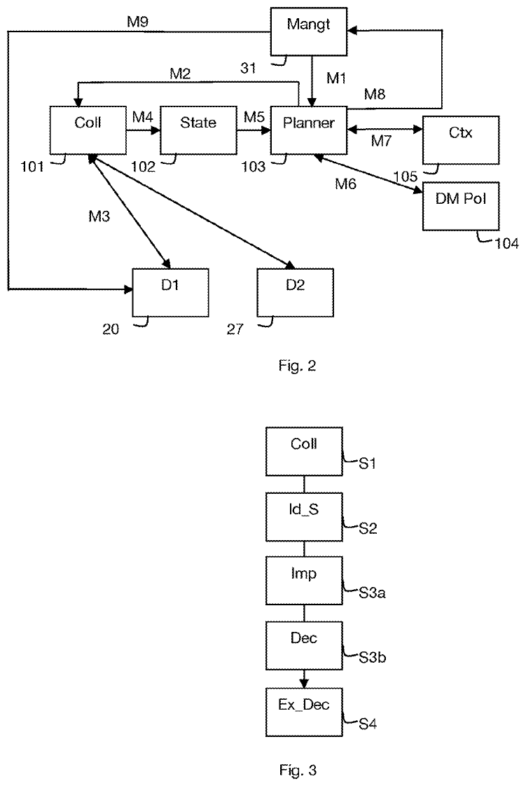

With reference to FIG. 2, a remote administration system comprises in particular:
the administration server 31 connected to a wide area communication network, designed to remotely administer a device;
a module 101 for collecting information relating to a device;
a module 102 for determining a state of use of a device;
a module 103 for scheduling a management operation to be executed.

The collection module 101 is in particular designed to obtain from a device of a local area network information relating to the device, such as an identifier of the device, information relating to the process(es) (and therefore to the service(s)) currently executing on the device, to the resources available on this device. The resources correspond for example to a processor capacity and its rate of use, an available random-access memory capacity, a storage capacity, a battery level. The process currently executing can be a service provided to a user of the device or else a service for management of the device executed by a remote administration device. This information is aimed at making it possible to determine a state of use of the device. The collection module 101 is designed to provide this obtained information to the module 102 for determining a state of use.

The module 102 for determining a state of use is in particular designed to obtain from the collection module 101 the information relating to a device and to determine a state of use of the device on the basis of this information. Hereinafter, this state of use is defined in the following manner:

“unavailable”: in this state, communication between the administration server and the device is possible but it is advised that no management operation be performed;

“used”: in this state, one or more services are currently executing and the device is partially available for a management operation;

“available”: in this state, no service is currently executing and the device is available for a management operation;

“reserved”: in this state, the device is reserved by another administration server for a management operation.

The “unavailable” state of use is determined as a function of the information obtained from the device. By way of illustration, when the battery level of a device is insufficient, it is advised that no update be performed so as to avoid an interruption during the execution of the latter. Still by way of illustration, when the random-access memory capacity is insufficient, it is advised that no update be performed so as to avoid a failure during the execution of the latter.

In a particular embodiment, the module 102 for determining a state of use is designed to provide an item of information relating to the main service associated with the device. By way of illustrative example, the main service associated with an STB decoder is the television service. Still by way of illustrative example, the main service associated with an access gateway is the Internet service.

In another particular embodiment, the module 102 for determining a state of use is designed to provide, when the state of use of the device is “unavailable” or “used”, complementary information relating to the state such as a list of identifiers of the services currently executing, of a set of available resources, a sub-state of the device (for example: battery unavailable, or processor unavailable). This embodiment makes it possible to have better precision as regards the impact of the execution of a management operation on the services currently executing on the device.

The scheduling module 103 is in particular designed to determine an impact of a management operation to be executed for a device as a function of the state of use of the device received from the determination module 102 and of the management operation to be executed Op.

The administration server 31 determines that a management operation Op is to be executed for a device and sends a request for scheduling of the management operation to be executed to the scheduling module 103.

An operation class Class_Op is defined, associated with each of the management operations. This operation class comprises the following classes:
updating of software or of firmware of the device;
action of writing for data stored by the device: configuration, writing, allocation (“provisioning”);
action of reading of data stored by the device: reading, monitoring;
diagnosis;
rebooting of the device.

An impact on the quality of service is determined for each management operation by the scheduling module 103:
definitive stoppage of the service;
temporary service interruption;
temporary service degradation;
no impact.

In a particular embodiment, when the impact is a temporary interruption of the service, an estimation of the duration of interruption is also determined.

The scheduling module 103 is thus designed to evaluate an impact of the management operation to be executed for the device.

In a particular embodiment, the scheduling module 103 also receives, when the state of use of the device is “unavailable” or “used”, complementary information such as a list of identifiers of the services currently executing, of a set of available resources. In this case, the scheduling module 103 is designed to evaluate a plurality of impacts of the management operation to be executed for each of the services determined currently executing.

The scheduling module 103 is also designed to determine a decision relating to the management operation to be executed on the basis of the state of use of the device, of the management operation to be executed and of the impact or impacts evaluated. More precisely, this decision corresponds to an authorization to execute the management operation or a request for postponement of the execution of the management operation. Accordingly, the scheduling module 103 is designed to obtain management operation execution policies, stored in a first memory area 104.

An association between a state of use of the device, an operation and an impact is called a management operation execution policy.

By way of first illustrative example, the impact of an update of firmware is a risk of temporary interruption on the device concerned in this update. The following execution policy is defined:

state of use=“available”, update, temporary service interruption, authorize the management operation
state of use=“used” or “unavailable” or “reserved”, update, temporary service interruption, postpone the management operation.

By way of second illustrative example, a reading of data on the device does not exhibit any impact. The following execution policy is defined:

state of use=“used” or “available” or “reserved”, reading, no impact, authorize the management operation
state of use=“unavailable”, reading, no impact, postpone the management operation.

It is recalled here that this is only an example and any other execution policy can be defined. For example, another execution management policy can indicate that the management operation can be postponed when the state of use of the device is “reserved”.

The scheduling module 103 is then designed to determine on the basis of the management operation execution policies obtained whether the execution of the management operation is authorized or postponed, and to send the decision relating to the requested management operation to the administration server 31.

In a particular embodiment, the scheduling module 103 is furthermore designed to obtain a context associated with a user of the device, stored in a second memory area 105. The context associated with a user of the device comprises one or more items of information relating to a user of the device or to the environment thereof.

By way of first illustrative example, the item of information obtained corresponds to a date, a time or a timeslot wherein the user accepts management operation execution. In a particular embodiment, this information has been parametrized by the user so as to adapt it to their own needs.

By way of second illustrative example, the item of information obtained corresponds to a criticality of the update to be executed, for example because it is associated with a security problem. This type of critical firmware or software update is authorized at any moment of the day even if it interrupts the services provided by the device and currently in use by the user.

When this update corresponds to a critical security update, the following execution policy is defined:

state of use=“unavailable” or “used” or “available”, critical security update, temporary service interruption, authorize the management operation
state of use=“reserved”, critical security update, temporary service interruption, postpone the management operation.

In the converse case, that is to say when this update does not correspond to a critical security update, the following execution policy is defined:

state of use=“unavailable” or “used” or “reserved”, update, temporary service interruption, postpone the management operation
state of use=“available”, update, temporary service interruption, authorize the management operation.

By way of third illustrative example, the item of information obtained corresponds to a profile of the user of the device. It is thus possible to define different management operation execution policies for so-called “premium” users, for whom the operator does not wish to disrupt the service provision, and for other so-called “tester” users, for whom the updates can be executed immediately, even if this entails disrupting the service provision.

When the user's profile is “premium”, the following execution policy is defined:

state of use=“available”, update, temporary service interruption, authorize the management operation
state of use=“unavailable” or “used” or “reserved”, update, temporary service interruption, postpone the management operation.

When the user's profile is “tester”, the following execution policy is defined:

state of use=“unavailable” or “used” or “available”, update, temporary service interruption, authorize the management operation
state of use=“reserved”, update, temporary service interruption, postpone the management operation.

Two actions in relation to the management operation are given in the above examples: authorize or request the postponement of the execution of the management operation. It is of course possible to define other actions. In a particular embodiment, the postponement of the execution of the management operation is time-limited. The decision sent to the administration server 31 then comprises a temporal item of information controlling an orchestration of the execution of the management operation. This temporal item of information is for example a duration of postponement or a date, allowing the administration server to orchestrate the execution of the management operation. The scheduling module 103 can then apply a policy of limitation of the postponement of the execution of a management operation by authorizing it when a certain duration has elapsed since the first request. The scheduling module 103 is thus designed to allow a scheduling of the execution of the management operation at a subsequent date. The administration server 31 is for its part in charge of orchestrating the execution of the management operation at a subsequent date as a function of the temporal item of information provided by the scheduling module 103.

On account of this scheduling, the quality of service provided to a user of the device is further improved.

The embodiment described comprises various modules, each of them being dedicated to a particular function of the administration method. It is recalled here that this split into modules is given by way of illustration. For example, in a particular embodiment, the collection module 101 and the module for determining state of use 102 are united into a single module. Other combinations of these modules are also possible. The location of these various modules, and their grouping if relevant, are selected by a person skilled in the art as a function of their choices and constraints of implementation.

In a particular embodiment, the device 20, 27 comprises the module 101 for collecting information, the module 102 for determining a state of use and the module 103 for scheduling a management operation. The device also comprises the first memory area 104 storing the management operation execution policies and if relevant the second memory area 105 storing information relating to the user or to the environment thereof. The device is thus in charge of authorizing, of postponing or of scheduling a management operation to be executed. This embodiment is adapted to devices having sufficient processing and memory capacities.

In a particular embodiment, the device 20, 27 comprises the module 101 for collecting information and the module 102 for determining a state of use. Another device, the administration device 40, located for example in the operator's network, then comprises the module 103 for scheduling a management operation, the first memory area 104 storing the management operation execution policies and if relevant the second memory area 105 storing information relating to the user or to their environment. This administration device 40 located in the operator's network is thus in charge of authorizing, of postponing or of scheduling a management operation to be executed. This embodiment is suitable for devices not having sufficient processing and memory capacities at their disposal. This embodiment is also suitable when the user does not wish to make available some of the device's resources. This other device is mandated to contribute to the implementation of the proposed administration method. This other device can also be the access gateway 20 in charge of the local area network to which the device to be administered belongs.

In a particular embodiment, an administration device 40, located for example in the operator's network, comprises the module 101 for collecting information, the module 102 for determining a state of use, the module 103 for scheduling a management operation, the first memory area 104 storing the management operation execution policies and if relevant the second memory area 105 storing information relating to the user or to their environment. The device to be administered comprises a module 208, cooperating with the collection module 101 so as to collect information relating to the device making it possible to determine an item of information in respect of state of use of the device. The administration device 40 located in the operator's network is thus completely in charge of authorizing, of postponing or of scheduling a management operation to be executed. This embodiment is suitable for devices not having sufficient processing and memory capacities at their disposal. This embodiment is also suitable when the user does not wish to make available some of the device's resources. This other device is mandated to contribute to the implementation of the proposed administration method. This other device can also be the access gateway 20 in charge of the local area network to which the device to be administered belongs.

These various embodiments can coexist so as to suit devices of various capacities. It is for example possible to obtain from the device an item of information relating to the embodiment chosen for the remote management:
the device to be administered is autonomous for implementing the administration method; the device to be administered schedules the management operations which are aimed at it,
the device to be administered cooperates with a device located in the network in order to implement the administration method:
   the device to be administered determines its state of use and the device located in the network schedules the management operation,
   or else the device to be administered sends solely the information making it possible to determine an item of information in respect of state of use of the device and the device located in the network determines the state of use and schedules the management operation.

It is stressed here that the proposed remote administration technique is independent of the application field of the administered devices.

In particular, it can be implemented in the field of domestic networks, in particular for the remote management of access gateways, TV decoders and connected televisions. It is thus possible to avoid a service interruption when a firmware update operation is requested by the administration server. It also makes it possible to avoid disturbing the client by asking the latter if they wish to postpone this update. On the basis of the TV program and on a context of use of the TV by the client, the proposed administration technique schedules a date for the update.

It can also be implemented in the medical field, in particular for the remote management of connected medical devices. These devices make it possible to transmit in real time data on the evolution of the patient's state of health to the care team. The proposed administration technique makes it possible to guarantee the transmission of this information on the basis of the state of use of the equipment. By taking into account a booking calendar for reserving the medical devices, the proposed administration technique schedules the management operation to be executed when the device is in an “available” state of use. As a function of the capacities of the device, the administration technique is implemented on the device itself or in the remote network.

In the field of connected objects, it is also possible to implement it in order to remotely manage for example a connected watch. In this case, the administration technique is preferably implemented in the network of the operator.

The remote administration technique will now be described in a particular embodiment in conjunction with FIGS. 2 and 3.

The execution of the following steps is triggered when a management operation must be executed on a device 20, 27 administered by the administration server 31.

The administration server 31 sends a message M1 requesting scheduling of a management operation to be executed to the scheduling module 103. This message M1 comprises, in particular, information relating to the management operation to be executed and an identifier of the device concerned in this management operation.

The scheduling module 103 then sends to the collection module 101 a message M2 requesting collection of information relating to the device.

The collection module 101 interrogates the device through a message M3 and obtains (step S1) in return an identifier of the device, information relating to the process(es) (and therefore to the service(s)) currently executing on the device, to the resources available on this device.

The collection module 101 transmits to the module 102 for determining a state of use the information obtained in a message M4.

The determination module 102 determines (step S2) a state of use of the device on the basis of this information and transmits said state in a message M5 to the scheduling module 103. This message M5 is received by the scheduling module 103 in response to the message M2 requesting collection of information relating to the device. In a particular embodiment, this message M5 comprises an item of information, determined by the determination module 102, relating to the main service associated with the device. In another particular embodiment, this message M5 comprises complementary information relating to the state, such as a list of identifiers of the services currently executing, of a set of available resources.

The scheduling module 103 then determines (step S3a) one or more impacts of the management operation to be executed in respect of the device as a function of the state of use of the device and of the management operation to be executed and (step S3b) a decision relating to the management operation to be executed on the basis of the state of use of the device, of the management operation to be executed and of the impact or impacts evaluated as a function of management operation execution policies read from the first memory area 104 (message M6).

The scheduling module 103 then sends the decision relating to the requested management operation to the administration server 31 in a message M8.

The administration server 31 then executes (step S4) the management operation in respect of the device concerned when the decision received from the scheduling module 103 corresponds to an authorization. This execution can be immediate or deferred. The administration technique is again implemented when the decision corresponds to a postponement of the management operation, with no indication of date.

In a particular embodiment, the scheduling module 103 also takes into account to determine the decision relating to the management operation to be executed one or more items of information, read from the second memory area 105 (message M7), relating to a user of the device or to the environment thereof.

In the particular embodiment described above, the scheduling module 103 sends the message M2 requesting collection of information relating to the device directly to the collection module 101. In another particular embodiment, the scheduling module 103 sends a message requesting state of use of the device to the module 102 for determining a state of use, which then sends the message requesting collection of information relating to the device to the collection module 101.

The device 20 administered by the administration server 31 comprises in particular in a particular embodiment, such as represented in FIG. 4:

a processor 200 for executing code instructions of software modules;

a memory area 202, designed to store an application which comprises code instructions for implementing the administration method, such as is described above;

a storage memory 204, designed to store data used during the implementation of the administration method, such as is described above;

a communication interface 206, designed to send and receive data;

a module 208, designed to collect information relating to the device making it possible to determine an item of information in respect of state of use of the device;

an administration module 210, designed to be administered remotely by an administration server, in particular to exchange administration data with this server.

It is stressed here that the device 20 also comprises other processing modules, not represented in FIG. 4, designed to implement the various functions of this device.

The administration module 210 implements for example the administration functions defined in technical report TR-069.

An administration device 40 is described with reference to FIG. 5 in a particular embodiment. The administration device 40 comprises in particular:
a processor 400 for executing code instructions of software modules;
a storage memory 402, designed to store data used during the implementation of the administration method, such as is described above;
a memory area 404, designed to store an application which comprises code instructions for implementing steps of the administration method, such as is described above;
a communication interface 406 with the wide area communication network, designed to dispatch and receive data.

In a particular embodiment, the device 20 comprises the collection module 101 (which can correspond to the module 208), the module for determining a state of use 102, the scheduling module 103 and the first memory area 104. It comprises if relevant the second memory area 105.

In a particular embodiment, the device 20 comprises the collection module 101 (which can correspond to the module 208) and the module for determining a state of use 102. The administration device 40, or any other device mandated to this effect, then comprises a module for obtaining the state of use cooperating with the module for determining a state of use, the scheduling module 103 and the first memory area 104. It comprises if relevant the second memory area 105.

In a particular embodiment, the device 20 comprises the module 208, designed to collect information relating to the device making it possible to determine an item of information in respect of state of use of the device, and the administration device 40, or any other device mandated to this effect, comprises the collection module 101, the module for determining a state of use 102, the scheduling module 103 and the first memory area 104. It comprises if relevant the second memory area 105.

The device to be administered and if relevant the administration device thus form a system designed to cooperate with the remote administration server. This system comprises:

at least one device to be administered 20, 27 comprising:
an administration module 210, designed to be administered remotely by an administration server 31;
a module 208, designed to collect information relating to the device making it possible to determine an item of information in respect of state of use of the device;
   this system furthermore comprising:
a determination module 102 for determining a state of use, designed to determine an item of information in respect of state of use of the device for which a management operation is to be executed;
a scheduling module 103, designed to determine a postponement of the execution of the management operation as a function of the item of information obtained, of an evaluation of an impact of the execution of the management operation on the functioning of the device and of a management operation execution policy and to request the postponement from the administration server.

In a particular embodiment, the system also comprises a collection module 101, designed to obtain information relating to the device making it possible to determine an item of information in respect of state of use of the device.

The administration technique is implemented by means of software components and/or hardware components. In this regard, the term “module” can correspond in this document either to a software component, or to a hardware component or to a set of hardware components and/or software components, able to implement a function or a set of functions, according to what is described above for the module concerned.

A software component corresponds to one or more computer programs, one or more subprograms of a program, or more generally to any element of a program or of a piece of software. Such a software component is stored in memory and then loaded and executed by a data processor of a physical entity and can access the hardware resources of this physical entity (memories, recording media, communication buses, electronic input/output cards, user interfaces, etc).

In the same manner, a hardware component corresponds to any element of a hardware set. It may or may not be a programmable hardware component, with or without an integrated processor for the execution of software. It is for example an integrated circuit, a chip card, an electronic card for the execution of firmware, etc.

In a particular embodiment, the modules 101, 102, 103 are designed to implement the administration method described above. These are preferably software modules comprising software instructions for executing code portions for the implementation of the administration method described above, during the execution of said program by the processor of a device. The invention therefore also relates to:

a program for a device, comprising program code instructions intended to control the execution of those of the steps of the above-described administration method which are implemented by the device, when said program is executed by this device;

a recording medium readable by a device on which the program for a device is recorded.

The software modules can be stored in or transmitted by a data medium. The latter can be a hardware storage medium, for example a CD-ROM, a magnetic diskette or a hard disk, or else a transmission medium such as an electrical, optical or radio signal, or a telecommunication network.

It goes without saying that the embodiments which were described above were given purely by way of wholly nonlimiting indication, and that numerous modifications can easily be made by a person skilled in the art without however departing from the scope of the invention.

1. An administration method of remote administration of a device by an administration server, said method comprising the following acts performed by the device to be administered or by a distinct administration device:
obtaining an item of information in respect of state of use of the device to be administered for which a management operation is to be executed;
evaluating an impact of execution of the management operation for a quality of service for a service provided by the device to be administered as a function of the item of information obtained and of the management operation to be executed;
determining a postponement of the execution of the management operation as a function of the item of information obtained, of said impact and of a management operation execution policy, defining an association between a state of use of the device to be administered, an operation and an impact;
requesting the postponement of the execution of the management operation from the administration server.

2. The administration method as claimed in claim 1, in which the request for postponement of the execution of the management operation comprises a temporal item of information allowing the administration server to orchestrate the execution of the management operation.

3. The administration method as claimed in claim 1, in which the postponement of the execution of the management operation is also determined as a function of a context associated with a user of the device to be administered.

4. The administration method as claimed in claim 1, in which the item of information in respect of state of use of the device to be administered is determined on the basis of information collected from the device to be administered.

5. The administration method as claimed in claim 4, in which the collected information belong to the group consisting of information relating to a process currently executing on the device to be administered and information relating to the resources available on the device to be administered.

6. The administration method as claimed in claim 1, in which the impact is evaluated as a function of a class of the management operation.

7. An administration device designed to cooperate with a server for remote administration of a device, the administration device comprising:
a processor; and
a non-transitory computer-readable medium comprising instructions stored thereon which when executed by the processor configure the administration device to:
obtain an item of information in respect of state of use of the device to be administered for which a management operation is to be executed;
evaluate an impact of execution of the management operation for a quality of service for a service provided by the device to be administered as a function of the item of information obtained and of the management operation to be executed, to determine a postponement of the execution of the management operation as a function of the item of information obtained, of an evaluation of said impact and of a management operation execution policy defining an association between a state of use of a device, an operation and an impact; and
request the postponement from the administration server.

8. The administration device as claimed in claim 7, in which the administration device is furthermore configured to determine the item of information in respect of state of use of the device to be administered on the basis of information collected from the device to be administered.

9. A system designed to cooperate with a remote administration server, said system comprising:
at least one device to be administered comprising:
a first processor; and
a first non-transitory computer-readable medium comprising instructions stored thereon which when executed by the first processor configure the device to be administered to:
be administered remotely by an administration server;
collect information relating to the device to be administered making it possible to determine an item of information in respect of state of use of the device to be administered; and
an administration device, which is implemented by the device to be administered or by another device in the system, wherein the administration device is configured to:
determine an item of information in respect of state of use of the device to be administered for which a management operation is to be executed; and
evaluate an impact of execution of the management operation for a quality of service for a service provided by the device to be administered as a function of the item of information obtained and of the management operation to be executed, to determine a postponement of the execution of the management operation as a function of the item of information obtained, of said impact and of a management operation execution policy defining an association between a state of use of a device, an operation and an impact and to request the postponement from the administration server.

10. The system as claimed in claim 9, wherein the administration device, which is implemented by the device to be administered or by another device in the system, is further configured to obtain information relating to the device to be administered making it possible to determine an item of information in respect of state of use of the device to be administered.

11. (canceled)

12. A non-transitory computer-readable recording medium on which a program is recorded that comprises instructions which when executed by a processor of a device to be administered or a distinct administration device, configure the device to be administered or the administration device to:
obtain an item of information in respect of state of use of the device to be administered for which a management operation is to be executed;
evaluate an impact of execution of the management operation for a quality of service for a service provided by the device to be administered as a function of the item of information obtained and of the management operation to be executed;
determine a postponement of the execution of the management operation as a function of the item of information obtained, of said impact and of a management operation execution policy, defining an association between a state of use of the device to be administered, an operation and an impact; and
request the postponement of the execution of the management operation from the administration server.
